(19) United States
(12) Patent Application Publication
(10) Pub. No.: US 2020/0231309 A1
(43) Pub. Date: Jul. 23, 2020

(54) MICRO-FUSION-POWERED AIR AND SPACE CRAFT

(71) Applicant: Jerome Drexler, Los Altos Hills, CA (US)

(72) Inventor: Jerome Drexler, Los Altos Hills, CA (US)

(21) Appl. No.: 16/251,524

(22) Filed: Jan. 18, 2019

(51) Int. Cl. B64G 1/40; B64G 1/26; G21H 7/00; G21B 3/00

(52) U.S. Cl. CPC B64G 1/408; G21B 3/004; G21H 7/00; B64G 1/26

(57) ABSTRACT

A micro-fusion powered craft has a centrally located internal chamber with an upper dome and a bottom opening. The chamber is radially surrounding by the main body of the craft. Ports from a fuel supply in the main body inject a deuterium-containing micro-fusion fuel material as a dispersed cloud within the chamber. Ambient cosmic rays and muons penetrate the upper dome into the chamber and interact with the fuel to produce energetic reaction products. The downwardly directed portion of the reaction products exist the chamber through the bottom opening to produce upward reaction thrust, while the upwardly directed portion of the reaction products are stopped by the upper dome to produce applied upward thrust. The craft may have one or more side ports for dispersing fuel material externally in a desired direction that reacts with ambient cosmic rays and muons to produce reaction products, at least some of which are received by a side of the craft to produce lateral thrust.

### TECHNICAL FIELD

The present invention relates to air or space craft for delivery of personnel and supplies from one location to another, and especially to such craft for use over the surfaces of the Moon, Mars, other planets or moons, as well as asteroids and similar space bodies. The invention also relates to inducement or production of controlled nuclear fusion by particle-target and muon-catalyzed micro-fusion for thrust in the presence of ambient cosmic rays and muons.

### BACKGROUND ART

For future creation of bases on the Moon and eventually on Mars, there will be a need to efficiently move personnel and supplies from place to place. Surface transport may sometimes be difficult because of terrain. However, there is no atmosphere on the Moon to support aerial flight, so another means of providing thrust and lift must be used. Although Mars does have an atmosphere, it is extremely thin (an average of 600 Pascals or only 0.6% of Earth's atmospheric pressure), and while gravity is only about 38% of that on Earth, aerial-style flight will be extremely difficult (e.g. number and length of rotor blades and their speeds would collectively need to increase about 60-fold for comparable lift).

At some high-altitude locations on Earth, aerial movement of personnel and supplies is difficult because it requires supporting infrastructure for landing of planes (airport runways, etc.) and exceeds maximum altitudes for safe operation of helicopters (which have a small landing footprint and don't need an airport).

Muon-catalyzed fusion was observed by chance in late 1956 by Luis Alvarez and colleagues during evaluation of liquid-hydrogen bubble chamber images as part of accelerator-based particle decay studies. These were rare proton-deuteron fusion events that only occurred because of the natural presence of a tiny amount of deuterium (about one part per 6400) in the liquid hydrogen. It was quickly recognized that fusion many orders of magnitude larger would occur with either pure deuterium or a deuterium-tritium mixture. However, John D. Jackson (Lawrence Berkeley Laboratory and Prof. Emeritus of Physics, Univ. of California, Berkeley) correctly noted that for useful power production there would need to be an energetically cheap way of producing muons. The energy expense of generating muons artificially in particle accelerators combined with their short lifetimes has limited its viability as an Earth-based fusion source, since it falls short of break-even potential.

Another controlled fusion technique is particle-target fusion which comes from accelerating a particle to sufficient energy to overcome the Coulomb barrier and interact with target nuclei. To date, proposals in this area depend upon using some kind of particle accelerator. Although some fusion events can be observed with as little as 10 KeV acceleration, fusion cross-sections are sufficiently low that accelerator-based particle-target fusion are inefficient and fall short of break-even potential.

It is known that cosmic rays are abundant in interplanetary space. Cosmic rays are mainly high-energy protons (with some high-energy helium nuclei as well) with kinetic energies in excess of 300 MeV. Most cosmic rays have GeV energy levels, although some extremely energetic ones can exceed 10¹⁸ eV. FIG. 6 shows cosmic ray flux distribution at the Earth's surface after significant absorption by Earth's atmosphere. In near-Earth space, the alpha magnetic spectrometer (AMS-02) instrument aboard the International Space Station since 2011 has recorded an average of 45 million fast cosmic ray particles daily (approx. 500 per second within that instrument's effective acceptance area and measurement energy range). The overall flux of galactic cosmic ray protons (above Earth's atmosphere) can range from a minimum of 1200 m⁻²s⁻¹sr⁻¹ to as much as twice that amount. (The flux of galactic cosmic rays entering our solar system, while generally steady, has been observed to vary by a factor of about 2 over an 11-year cycle according to the magnetic strength of the heliosphere.) In regions that are outside of Earth's protective magnetic field (e.g. in interplanetary space), the cosmic ray flux has been estimated to be several orders of magnitude greater. As measured by the Martian Radiation Experiment (MARIE) aboard the Mars Odyssey spacecraft, average in-orbit cosmic ray doses were about 400-500 mSv per year, which is an order of magnitude higher than on Earth.

Cosmic rays are known to generate abundant muons from the decay of cosmic rays passing through Earth's atmosphere. Cosmic rays lose energy upon collisions with atmospheric dust, and to a lesser extent atoms or molecules, generating elementary particles, including pions and then muons, usually within a penetration distance of a few cm. Typically, hundreds of muons are generated per cosmic ray particle from successive collisions. Near sea level on Earth, the flux of muons generated by the cosmic rays' interaction by the atmosphere averages about 70 m⁻²s⁻¹sr⁻¹. The muon flux is even higher in the upper atmosphere. These relatively low muon flux levels on Earth reflect the fact that both Earth's atmosphere and geomagnetic field substantially shield our planet from cosmic ray radiation, although the amount of shielding is somewhat lower and thus the cosmic ray flux and muon generation are greater at higher elevations and altitudes. Mars is a different story, having very little atmosphere (only 0.6% of Earth's pressure) and no magnetic field, so that muon generation at Mars' surface is expected to be very much higher than on Earth's surface.

### SUMMARY DISCLOSURE

The present invention provides micro-fusion powered craft for use above the lunar and Martian surfaces, where the micro-fusion provides thrust for generating lift and propulsion. The propulsion technology takes advantage of the abundance of cosmic rays in space to catalyze fusion events in enough amounts to produce useable thrust. The cosmic rays together with muons generated from such cosmic rays are available here for free and do not need to be generated artificially in an accelerator. The thrust enables flight above the lunar or planetary surface, including an ability to haul cargo and personnel up to some maximum weight that is dependent upon the amount of lift and propulsion provided by the micro-fusion.

A craft is provided with a centrally located internal chamber with a dome on top and opening at the bottom. A small amount of deuterium-containing micro-fusion fuel material is inwardly injected into this chamber. Ambient cosmic rays and/or muons penetrate the dome from above and interact with the fuel material to generate energetic alpha particles and/or other reaction products that provide lifting thrust to the craft. In particular, downwardly-directed alpha particles escape through the opening to produce an upward reaction thrust, while upwardly-directed alpha particles are stopped by the dome and produce upward applied forces against the craft. Further, any fuel escaping through the bottom opening will also react externally with ambient cosmic rays and muons and resulting reaction products will apply upward forces upon the underside of the craft.

For lateral motion, the attitude of the craft may be tilted (e.g. by shifting center of mass) so that the thrust will have a lateral as well as vertical component. Alternatively, the location of the opening at the bottom of the chamber might be moveable so that the selection of which generally downward-directed alpha particles escape and produce reaction thrust can vary. Still further, the bottom opening may have a deflection mechanism (e.g. based on electrostatic fields) that redirects or steers some or all the escaping alpha particles in a more lateral direction.

The craft might also be provided with a set of external side ports for lateral motion. Deuterium-containing micro-fusion fuel material is ejected from one or more selected ports to form a cloud of material that interacts with the ambient cosmic rays and/or muons. Energetic micro-fusion reaction products interact with the side of the craft to provide lateral thrust moving the craft in a desired direction.

### BRIEF DESCRIPTION OF THE DRAWINGS

FIG. 1 is a schematic side view showing an embodiment of a craft for operation above a planet's or moon's surface in the presence of ambient cosmic rays and muons and having micro-fusion generated thrust for lift and propulsion.

FIG. 2 is a side sectional view showing of the internal reaction chamber of the craft in FIG. 1.

FIG. 3 is a side sectional view showing a craft as in FIG. 1 whose attitude is tilted to one side for lateral propulsion.

FIG. 4 is a side sectional view of an internal reaction chamber as in FIG. 2, but with a movable bottom opening for directional selection of escaping reaction products.

FIG. 5 is a side perspective view of a bottom opening of an internal reaction chamber as in FIG. 2, but having a deflection mechanism for escaping reaction products.

FIG. 6 is a graph of cosmic ray flux at the Earth surface versus cosmic ray energy, after very significant cosmic ray absorption by Earth's atmosphere has occurred.

### DETAILED DESCRIPTION

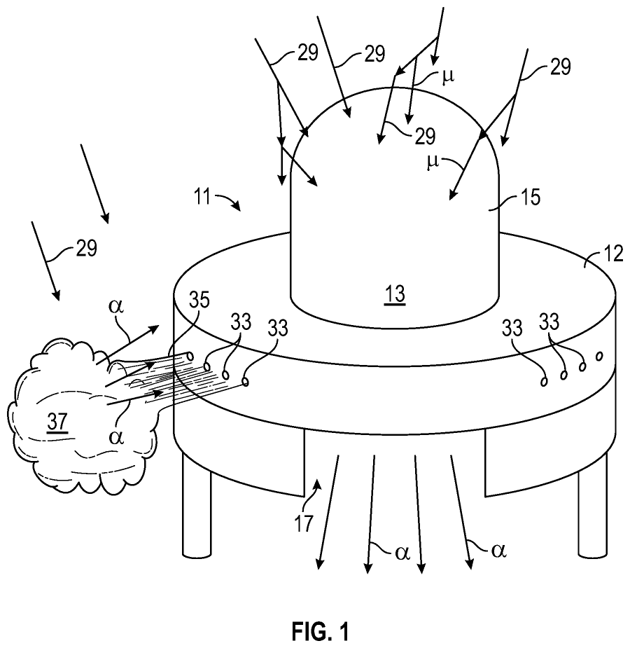

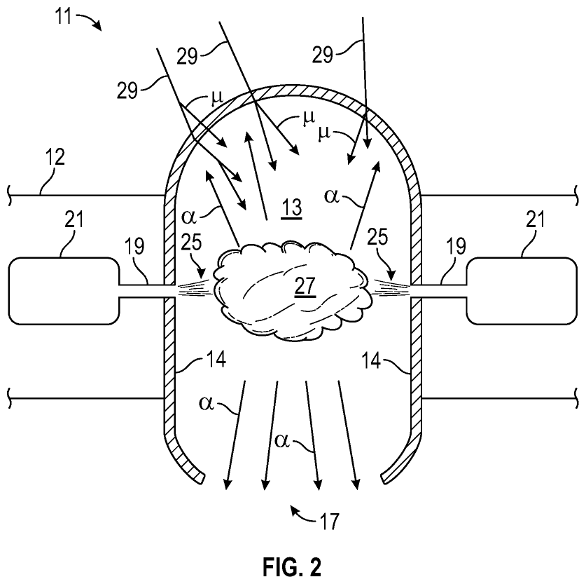

With reference to FIGS. 1 and 2, a craft 11 has a centrally located internal chamber 13 with a dome 15 on top and an opening 17 at the bottom. The craft 11 therefore constitutes a roughly toroidal, tubular or doughnut-shaped main body portion surrounding an internal chamber 13 which can extend somewhat above the top of the craft body by means of a bubble region with a dome 15 serving as a cover for the chamber 13.

The dome 15 is effectively transparent to cosmic rays, with their extremely high energies (>100 Mev) and penetrating power, but essentially opaque to the substantially lower energy (˜10 MeV) alpha particle reaction products that will thus be stopped by the dome. It is expected that the dome material can be the same as the external skin 12 of the craft 11, but thinner. However, research and development efforts may optimize the choice of dome material and its thickness to achieve maximum cosmic ray penetration into the chamber 13, as well as to facilitate production of muons through interactions of those cosmic rays with the dome material. The dome 15 might even be double-paned structure with wire mesh, fibers and or even fine particulates to enhance muon creation. (Such a double-paned structure may also facilitate the provision of a cooling water or gas flow between the panes.) Such the presence of muon generators as a permanent structure of the dome 15 will lessen or even eliminate the need for having muon-generating particulate material with the fuel, thereby saving valuable fuel weight.

Additionally, the amount of curvature of the dome may be important to maximizing input of cosmic rays and muons into the chamber 13. The curvature of the “dome” may range from being completely flat to extending considerably upward above the top of the remainder of the craft 11, perhaps as much as twice as high as its radius. The much larger surface area of a large curvature dome 15 would facilitate cooling of the cover as it bombarded with ambient cosmic rays penetrating from outside and with micro-fusion reaction products (energetic alpha particles a) from within. A larger curvature might also allow relief of mechanical stresses from any heating that does result.

Except for fuel injection ports 19 leading into the chamber 13, the internal chamber is otherwise isolated from the rest of the craft 11 that radially surrounds it. Specifically, the sides 14 of the chamber 13, seen in FIG. 2, preferably provide sufficient radiation shielding to protect the craft's occupants and supplies, as well as stored fuel not yet injected into the chamber 13.

One or more fuel injection ports 19 are positioned in the sides 14 of the chamber 13 for ejecting micro-fusion fuel particles 25 from a stored supply 21 to create a cloud 27 of such material within the chamber 13. Ambient cosmic rays 29 and muons p generated from those cosmic rays penetrate the dome 15 and react with the cloud 27 of micro-fusion material to generate energetic fusion products, such as alpha particles a. At least some of these energetic fusion products are received by the craft 11 to provide upward thrust or lift. Specifically, some of the alpha particles a will be directed downward and escape through the opening 17 at the bottom of the chamber. These will provide an upward reaction thrust. Other alpha particles a will be directed upward and be stopped by the dome 15. These will produce an upward applied force against the craft 11. Alpha particles a directed laterally in all directions will provide counteracting effects and negligible thrust contributions. Some of the deuterium-containing micro-fusion fuel material will also escape through the opening 17 in the bottom of the chamber 13. However, immediately outside the craft 11, such fuel will also interact with ambient cosmic rays and muons to generate micro-fusion reaction products (alpha particles a) at least some of which will be directed upward onto the underside of the craft 11. These will likewise apply an upward force upon the craft 11. The combination of contributing upward forces will produce lift.

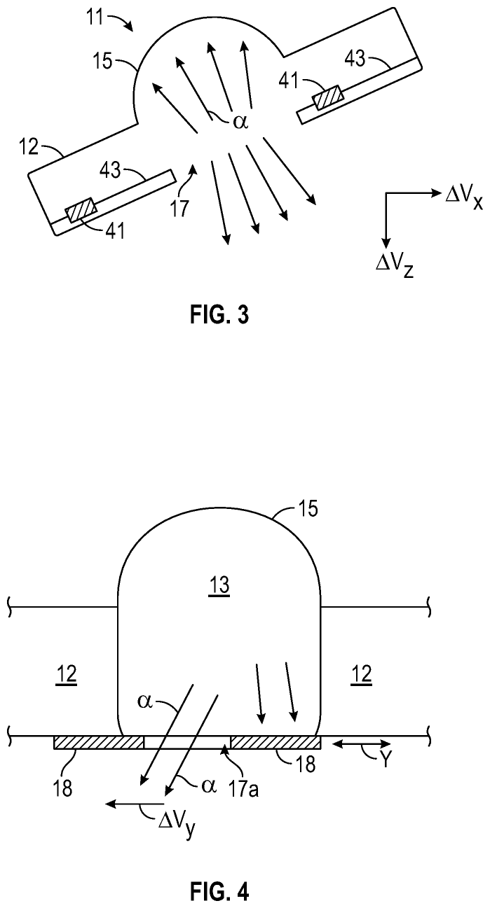

With reference to FIG. 3, the craft 11 may be given an attitudinal tilt, e.g. by providing one or more movable weights 41 in the main body 12 of the craft. Such weights 41, which can be movable along rods or screws 43, shifts the center of mass and hence the balance of the craft, thereby tilting the craft in one direction or another. Energetic alpha particles a impinging upon the dome 15 or escaping through the bottom opening 17 provide, not only a vertical component of thrust ΔVz, but also a horizontal component of thrust ΔVx, thereby allowing for lateral motion.

With reference to FIG. 4, yet another way to produce lateral thrust might be to have the bottom opening 17a in the chamber 13 be laterally moveable. For example, a plate 18 with the opening 17a therein might slide in a reciprocating (or even rotating) motion Y along the underside of the main craft body 12. Only certain alpha particles a traveling in a selected partially lateral trajectory can escape through the opening 17a, depending on its position, so that a preferential lateral thrust ΔVy is produced.

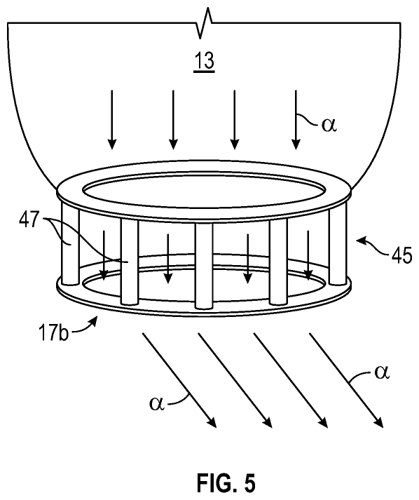

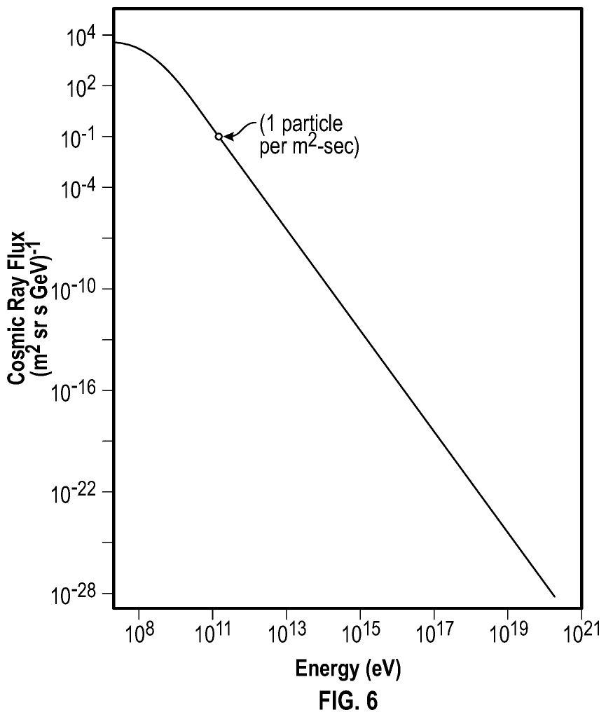

With reference to FIG. 5, in a still further way of producing lateral thrust, because alpha particles have an electric charge, a deflection mechanism 45 at the bottom opening 17b of the chamber 13 can deflect or steer the alpha particles a and give them a lateral component of motion. For example, one mechanism for deflecting alpha particle exhaust can create an electric field using a set of tungsten rods 47, each having a different selected voltage. The voltage differential creates a lateral field that deflects alpha particles traversing the space between those rods 47. The alpha particles have a positive charge whose trajectory is influenced by the lateral electric field. The size and direction of that field can be varied by changing the voltages applied to the various rods 47, thereby varying the field. The amount of electricity required for deflection should be relatively small.

Returning to FIG. 1, the craft 11 may also have a set of side ports 33 located at various places around the craft. Selected side ports 33 eject micro-fusion particle material 35 to form a cloud 37 that likewise interacts with the ambient cosmic rays 29 and muons p to produce energetic micro-fusion products, such as alpha particles a, at least some of which are then received by that side of the craft 11 to provide lateral thrust in a desired direction. Selection of one or more side ports 33 change the direction of lateral movement. Also, if the craft can rotate, then fewer side ports 33 may be needed to achieve the same range of desired lateral movement.

Using any of these methods a pilot can vary the speed and direction of the craft 11 by varying the amount and direction of lateral thrust provided by the alpha particles.

The fuel can be solid Li⁶D in powder form, D-D or D-T inertial-confinement-fusion-type pellets, or D₂O ice crystals, or even droplets of (initially liquid) D₂. Various types of micro-fusion reactions may also occur, such as Li⁶-D reactions, generally from direct cosmic ray collisions, as well as D-T, using tritium generated by cosmic rays impacting the lithium-6. D-T reactions especially may be assisted by muon-catalyzed fusion.

The dispersed cloud of micro-fusion target material will be exposed to ambient cosmic rays and muons. To assist muon formation, the micro-fusion fuel material may contain up to 20% by weight of added particles of fine sand or dust. As cosmic rays collide with the micro-fusion material and dust, they form muons p that are captured by the deuterium and that catalyze fusion. Muon formation may also be facilitated by reaction of cosmic rays with the dome material. Likewise, the cosmic ray collisions themselves can directly trigger particle-target micro-fusion.

The amount of energy generated by the micro-fusion reactions, and the thrust the micro-fusion products produce, depends upon the quantity of fuel injected into the chamber 13 and the quantity of available cosmic rays and muons in the ambient environment that can enter the craft through the dome 15. Assuming much of the energy can be captured and made available for thrust, an estimated 10¹⁵ individual micro-fusion reactions (less than lpg of fuel consumed) per second would be required for 1 kW output. But as each cosmic ray can create hundreds of muons and each muon can catalyze about 100 reactions, the available cosmic ray flux in interplanetary space (believed to be several orders of magnitude greater than on Earth) is believed to be sufficient for this thrust purpose following research, development, and engineering efforts.

The micro-fusion fuel material may be sprayed continuously as needed to sustain the clouds both within the chamber 13 and externally adjacent to the craft 11. For the external side ports 33, the fuel can be ejected in the form of projectiles. The projectiles would then chemically explode when it reaches a desired distance from the craft 11 to disperse its micro-fusion particle fuel load and create the external cloud. The amount of micro-fusion target material expended is quite small, since less than 1 μg of fuel material reacted per second would be required for 1 kW output. Exact amount of fuel needed will depend upon the ambient cosmic ray and muon flux and the reaction cross-sections for achieving the desired number (e.g. 10¹⁵) of reactions per second.

The volume of the continuous slow fusion creates high velocity fusion products (fast alpha particles or helium “wind”, etc.) that bombard the exterior of the craft. The energetic alpha particle micro-fusion products (a) provide thrust against the craft.

Stored fuel 21 will be shielded within the craft 11 to reduce or eliminate premature micro-fusion events until delivered and dispersed as a cloud in the interior chamber or outside the craft for thrusting. However, one need not completely eliminate cosmic rays or their secondary particles (pions, muons, etc.) to zero, but merely reduce their numbers and energies sufficiently to keep them from catalyzing large numbers of micro-fusion events in the stored target particle material.

The muon-catalyzed and direct particle-target micro-fusion for providing the thrust may be used on the Moon, Mars, Martian moons, asteroid or possibly even Earth for lightweight craft at higher elevations and altitudes. Simple, inexpensive observation drones can be operated at a variety of altitudes and speeds. The design can be optimized for a particular space body. Specifically, as in FIG. 1, each craft could have two sources of micro-fusion thrust: one to achieve and maintain altitude, and at least one other to provide horizontal motion.

Because the technology is still early in a developmental phase, testing of its concepts might be perfected at some locations on Earth before its deployment in outer space, even though the ambient flux of cosmic rays and muons is expected to be orders of magnitude lower due to Earth's geomagnetic field and thick atmosphere. For testing purposes, ultra-lightweight drone craft under 5 kg may be used, especially at higher altitudes. (Both cosmic ray flux and muon generation are known to substantially increase with altitude.) Testing with ultra-lightweight craft at convenient higher altitude Earth locations would allow designers to improve the proposed micro-fusion engines before their use on the Moon and then on Mars. Additionally, such craft might serve to deliver supplies on Earth at higher elevations and altitudes, especially wherever a small landing footprint is needed but elevations are too high for helicopters to reach.

When used on Earth, some care will be needed when using some micro-fusion fuels. For example, lithium hydride (including Li⁶D) is known to be violently chemically reactive in the presence of water. While reactions with water are not a problem on the Moon or Mars, with any Earth applications the fuel material will need to be encapsulated to isolate it from water sources, including atmospheric vapor. A desiccant can also be used when storing the fuel material.

What is claimed is:

1. A propulsion system for use by an air or space craft in the presence of an ambient flux of cosmic rays, comprising:
a central chamber located within a craft and surrounded by a main craft body, the central chamber having an upper dome and a bottom opening, side walls of the chamber having one or more ports for injection of deuterium-containing particle fuel material, the material interacting with the ambient flux of cosmic rays entering the chamber through the upper dome to generate reaction products having kinetic energy, a downwardly directed portion of the reaction products exiting the chamber through the bottom opening to produce reaction thrust and an upwardly directed portion of the reaction products being stopped by the upper dome to produce upward applied thrust upon the craft; and
at least one external side port for ejecting deuterium-containing particle fuel material in a specified direction outside the craft, the ejected particle fuel material interacting with the ambient flux of cosmic rays to produce energetic reaction products, at least a portion of the such external reaction products being received by the outside of the craft to produce lateral thrust.

2. The propulsion system as in claim 1, wherein the upper dome is double-paned and includes muon generating material therebetween, collisions of cosmic rays with the muon generating material supplying muons to the deuterium-containing particle fuel material to facilitate generation of energetic reaction products.

3. The propulsion system as in claim 1, wherein the upper dome is double-paned and includes a thermal coolant circulating between the panes.

4. The propulsion system as in claim 1, wherein the bottom opening has a moveable position relative to the chamber, such that the downwardly directed portion of the reaction products exiting the chamber is selectable with respect to a lateral component of motion, whereby reaction thrust provides both lift and lateral motion in a direction specified by the moveable position of the bottom opening.

5. The propulsion system as in claim 1, wherein the bottom opening has a deflection mechanism for selectively deflecting electrically charged reaction products escaping through the bottom opening, the selective deflection producing a specified direction of lateral motion.

6. The propulsion system as in claim 1, wherein the deuterium-containing particle fuel material comprises Li⁶D.

7. The propulsion system as in claim 1, wherein the deuterium-containing particle fuel material comprises D₂O.

8. The propulsion system as in claim 1, wherein the deuterium-containing particle fuel material comprises D₂.

9. The propulsion system as in claim 1, wherein the deuterium-containing particle fuel material is in solid powder form.

10. The propulsion system as in claim 1, wherein the deuterium-containing particle fuel material is in pellet form.

11. The propulsion system as in claim 1, wherein the deuterium-containing particle fuel material is in frozen form.

12. The propulsion system as in claim 1, wherein the deuterium-containing particle fuel material is in liquid droplet form.

13. The propulsion system as in claim 1, wherein the deuterium-containing particle fuel material is projected outward from the craft as successive packages.

14. The propulsion system as in claim 13, wherein each package is configured to disperse the deuterium-containing particle fuel material as localized cloud at a specified distance from the craft.

15. The propulsion system as in claim 1, wherein the fuel material also contains up to 20% by weight of added particles of fine sand or dust to facilitate generation of muons from the ambient cosmic rays.

16. A method, operable in the presence of an ambient flux of cosmic rays, of producing lifting thrust upon a craft, comprising:
injecting deuterium-containing particle fuel material into an internal chamber of the craft, the chamber having an upper dome and a bottom opening, the material interacting with the ambient flux of cosmic rays and muons generated from the cosmic rays penetrating the upper dome to generate reaction products having kinetic energy inside the chamber, a downwardly directed portion of the reaction products exiting the chamber through the bottom opening to produce reaction thrust and an upwardly directed portion of the reaction products being stopped by the upper dome to produce upward applied thrust upon the craft.

17. The method as in claim 16, wherein a cloud of the deuterium-containing particle fuel material is further dispersed in a specified direction into the immediate vicinity of an exterior of the craft, the fuel material interacting with ambient cosmic rays and muons such that generated kinetic-energy-containing products create lateral thrust upon the craft.

18. The method as in claim 16, wherein the bottom opening has a moveable position relative to the chamber and the downwardly directed portion of the reaction products exiting the chamber is selected with respect to a desired lateral component of motion, whereby reaction thrust provides both lift and lateral motion in a direction specified by the moveable position of the bottom opening.

19. The method as in claim 16, wherein the bottom opening has an electrostatic deflection mechanism and reaction products escaping through the bottom opening are laterally deflected to produce a specified component of lateral thrust.

20. A craft operable above a planetary, lunar or asteroid surface in the presence of ambient cosmic rays, comprising:
a main craft body surrounding a central chamber with an upper dome and a bottom opening, the craft body having a supply of deuterium-containing particle fuel material coupled through one or more ports in side walls of the chamber for injection of the fuel material into the chamber, the material interacting with the ambient flux of cosmic rays entering the chamber through the upper dome to generate reaction products having kinetic energy, a downwardly directed portion of the reaction products exiting the chamber through the bottom opening to produce reaction thrust and an upwardly directed portion of the reaction products being stopped by the upper dome to produce upward applied thrust upon the craft.

21. The craft as in claim 20, further comprising at least one external side port in the main craft body for ejecting deuterium-containing particle fuel material specified direction outside the craft, the ejected particle fuel material interacting with the ambient flux of cosmic rays to produce energetic reaction products, at least a portion of the such external reaction products being received by the outside of the craft to produce lateral thrust.

22. The craft as in claim 20, wherein the upper dome is double-paned and includes muon generating material therebetween, collisions of cosmic rays with the muon generating material supplying muons to the deuterium-containing particle fuel material to facilitate generation of energetic reaction products.

23. The craft as in claim 20, wherein the upper dome is double-paned and includes a thermal coolant circulating between the panes.

24. The craft as in claim 20, wherein the bottom opening has a moveable position relative to the chamber, such that the downwardly directed portion of the reaction products exiting the chamber is selectable with respect to a lateral component of motion, whereby reaction thrust provides both lift and lateral motion in a direction specified by the moveable position of the bottom opening.

25. The craft as in claim 20, wherein the bottom opening has a deflection mechanism for selectively deflecting electrically charged reaction products escaping through the bottom opening, the selective deflection producing a specified direction of lateral motion.

26. The craft as in claim 20, wherein the main craft body includes a set of one or moveable weights for shifting a center of mass of the craft to tilt an attitude of the craft in a specified direction, the tilt introducing a lateral component of thrust from both the reaction products exiting the bottom opening of the chamber and impinging upon the upper dome of the chamber.
